(19) United States
(12) Patent Application Publication
(10) Pub. No.: US 2023/0292756 A1
(43) Pub. Date: Sep. 21, 2023

(54) AQUEOUS DESINFECTANT COMPOSITION FOR GLASSES

(71) Applicant: Unifarco S.p.A., Santa Giustina (BL) (IT)

(72) Inventors: Giovanni Baratto, Santa Giustina (BL) (IT); Laura Busata, Santa Giustina (BL) (IT)

(73) Assignee: Unifarco S.p.A., Santa Giustina (BL) (IT)

(21) Appl. No.: 17/999,906

(22) PCT Filed: May 28, 2020
(86) PCT No.: PCT/IT2020/000044

§ 371 Date: Nov. 25, 2022

(51) Int. Cl. A01N 43/50; A01N 31/08; A01N 33/12; A01N 25/02; A01N 25/30

(52) U.S. Cl. CPC A01N 43/50; A01N 31/08; A01N 33/12; A01N 25/02; A01N 25/30

(57) ABSTRACT

The object of the invention is an aqueous disinfectant composition for glasses comprising the following active substances: a) imidazolidinyl urea, b) o-cymen-5-ol, c) cetrimonium chloride. Preferably, said aqueous disinfectant composition for glasses father comprises d) methylchloroisothiazolinone and e) methylisothiazolinone.

### FIELD OF THE INVENTION

The field of the present invention relates to an aqueous disinfectant composition for glasses.

### BACKGROUND OF THE ART

Those who wear glasses, wheter prescription glasses or sunglasses, must clean them for a correct and optimal vision. Periodic cleaning of the glasses, especially lenses, guarantees the transparency thereof. When the lens transparency partially or completely lack, the subject's eyes tend to tire. In these cases, the stress to which the subject's eye is subjected represents an attempt to improve the vision of the external world by involuntarily adapting to it with a forced focusing system. In fact, the eye fatigue phase stops when the subject decides to polish his/her pair of glasses.

For a person driving a vehicle, glasses and especially lenses that are not carefully cleaned or simply breathed can constitute a danger to road safety.

Furthermore, dirty lenses can cause visual problems and/or worsening of pre-existing visual defects due to poor focus. Poor hygiene and cleaning of the glasses could also lead to an increased risk of developing viruses or microorganism populations, such as bacteria, mold and/or yeasts.

Dust, rain, sweat and city smog are counting causes that contribute to the daily soiling of glasses.

The pandemic caused by the SARS-CoV-2 coronavirus, which developed at the end of the year 2019, required the use not only of personal protective equipment (masks and gloves), but also of disinfectant solutions for more or less wide surfaces.

WHO guidelines (WORLD HEALTH ORGANIZATION, et al. Water, Sanitation, hygiene, and waste management for the COVID-19 virus: interim guidance, 23 Apr. 2020. World Health Organization, 2020) provide for the use in particular of:
an aqueous solution of ethyl alcohol at 70% (v/v) by volume to the total volume of the aqueous solution, preferably for disinfecting objects or limited areas;
an aqueous solution of sodium hypochlorite at 0.5% (w/w) by weight to the total weight of the aqueous solution, preferably for disinfecting larger surfaces.

The anti-Covid19 aqueous disinfectant solutions proposed by WHO and, in general, the known solutions for the disinfection of surfaces against viruses and/or microorganisms, such as bacteria, yeasts and/or molds, are however somewhat aggressive considering the hygiene and the cleaning of the glasses since the materials with which they are manufactured (commonly metal, plastic, acetate, titanium, polyamide or optyl) are delicate and could experience irreversible alterations.

Furthermore, the possible use of concentrated aqueous ethyl alcohol solutions is to be considered risky because these solutions are potentially flammable.

### SUMMARY OF THE INVENTION

The Applicant has developed an aqueous disinfectant composition comprising the following active substance:
a) imidazolidinyl urea,
b) o-cymen-5-ol,
c) cetrimonium chloride.
   optionally in association with d) methylchloroisothiazolinone and e) methylisothiazolinone.

The aqueous disinfectant composition according to the present invention, in particular, is advantageous because it allows a correct disinfection of the glasses and lenses, due to the efficacy of all the active substance against viral, including Covid-19, and/or microbial pathogens; in addition, it fulfils its effectiveness as a disinfectant also against yeasts and molds.

The Applicant has also found that none of the active substance a)-c), and, when present, also the components d) and e) do affect the materials from which the glasses are commonly made; finally it is not flammable.

### DESCRIPTION OF THE FIGURES

FIG. 1—Comparison between “blank” sample and PROT. 2064

FIG. 2—Comparison between “blank” sample and PROT. 2071

FIG. 3—Comparison between “blank” sample and PROT. 2079

FIG. 4—Comparison between “blank” sample and PROT. 2080

FIG. 5—Comparison between “blank” sample and PROT. 2081

FIG. 6—Comparison between “blank” sample and PROT. 2082

FIG. 7a—Killing rate % of the Gram+ bacteria S. aureus

FIG. 7b—Killing rate % of the Gram+ bacteria S. epidermidis

FIG. 8a—Killing rate % of the Gram− bacteria E. coli

FIG. 8b—Killing rate % of the Gram− bacteria P. aeruginosa

FIG. 9—Killing rate % of enveloped viruses HSV-1

### DETAILED DESCRIPTION OF THIS INVENTION

For the purposes of the present invention, the verbs “to comprise” or “to contain” are intended to define a set of elements, expressly indicating some of them, without excluding the presence of others not expressly indicated; while the term “consisting of” or “consists of” is intended to define a set of elements, indicating them all expressly, and thus excluding the presence of components not expressly listed.

By “aqueous composition” is intended a water-based composition the main component of which is water preferably between 80 and 98%, more preferably between 85 and 95% by weight on the total weight of said composition.

By “glasses” is intended an optical instrument consisting of a pair of transparent lenses, fixed to a support (frame) that keeps them fixed in front of the eyes. The glasses have the function of compensating the refractive defects of the eye (corrective glasses or commonly prescription glasses), or to protect the eyes from the harmful action of radiation or external mechanical agents (protective glasses or commonly sunglasses).

The antiviral and antimicrobial action, and the action against other microorganisms, such as yeasts and/or molds, is supported by the following pool of preserving ingredients (or preservatives), commonly used for cosmetic use:
a) imidazolidinyl urea, a preservative capable of releasing formaldehyde;
b) o-cymen-5-ol, a preservative efficacy of which on the influenza virus has been demonstrated at concentrations of 0.02% (w/w) by weight to the total weight of the known formulation;
c) cetrimonium chloride, a positively charged quaternary surfactant.

Preferably the aqueous composition of the invention also includes d) methylchloroisothiazolinone and e) methylisothiazolinone.

Preferably the composition of the invention contains the active substance a) at concentrations ranging from 0.1 to 1%, more preferably from 0.1 to 0.6%, by weight on the total weight of the composition.

Preferably the composition of the invention contains the active substance b) at concentrations comprised between 0.005 and 0.5%, more preferably between 0.01 and 0.2%, by weight on the total weight of the composition.

Preferably the composition of the invention preferably contains the active substance c) at concentrations ranging from 0.05 to 1%, more preferably from 0.05 to 0.8%, by weight on the total weight of the composition.

When the aqueous disinfectant composition object of the present contains the active substance d), this is preferably present at concentrations comprised between 0.0005 and 0.01%, preferably between 0.0005 and 0.005%, by weight on the total weight of the aqueous disinfectant composition.

When the aqueous composition also contains the component e) this is preferably present at concentrations between 0.0001 and 0.01%, more preferably between 0.0001 and 0.001%, by weight on the total weight of the aqueous disinfectant composition according to the present invention.

Preferably, the disinfectant composition object of the invention is also cleansing, and in such a case it comprises a surfactant. Preferably this surfactant is chosen from sodium cocoamphoacetate, sodium lauryl ether sulphate and cocamidopropyl betaine.

According to a particularly preferred solution, the disinfectant and detergent aqueous composition preferably includes sodium cocoamphoacetate as surfactant.

In fact, the applicant found that, compared to the other two surfactants—sodium lauryl ether sulphate and cocamidopropyl betaine—sodium cocoamphoacetate shows the best performances in terms of foaming, degreasing capability and possible formation of post halos upon drying the lenses.

Sodium cocoamphoacetate is preferably present in the composition of the invention at concentrations ranging from 0.05 to 5%, more preferably from 0.1 to 1.5%, by weight on the total weight of the composition.

The composition according to the present invention preferably also includes a chelating agent, more preferably disodium-EDTA. According to particularly preferred solutions this chelating agent is at concentrations comprised between 0.05 and 1%, and, according to even more preferred solutions, at concentrations comprised between 0.1 and 0.6% by weight on the total weight of the composition.

The Applicant has surprisingly found that this chelating agent, disodium-EDTA, is a strong stabilizer of said aqueous disinfectant composition, since it reduces its aggressivness towards glasses, in particular in the case of mirrored sunglasses. Usually the mirroring technique of glasses involves the use of different metal ions in a mixture. Being a chelator, disodium-EDTA could, in fact, partially or totally sequester said metal ions, thus affecting the lenses mirroring of the glasses, a phenomenon which however does not occur due to the presence of this chelating agent.

o-cymene-5-ol, being fat soluble and in a needle-like form, it is scarcerly soluble in an aqueous medium, and a C2-C4 lower alcohol is preferably used as solubilizer, more preferably ethyl alcohol in amounts such as to allow solubilization in water of this active substance, and at the same time to prevent said ethyl alcohol, potentially aggressive for the materials with which glasses are commonly manufactured, from affecting the integrity thereof. Ethyl alcohol is also used in amounts such as to obtain a non-flammable aqueous disinfectant composition of the invention.

The concentration of ethyl alcohol in the composition of the invention is comprised between 1 and 20%, preferably between 1 and 15%, by weight on the total weight of the composition according to the present invention.

Said disinfectant composition can also contain stabilizing agents of methylchloroisothiazolinone and methylisothiazolinone.

These stabilizers are preferably selected from the group consisting of: magnesium chloride, magnesium nitrate and mixtures thereof.

The disinfectant composition object of the present invention as such, and even when it has cleasing properties, has high compatibility with the materials with which the glasses are manufactured; moreover, it minimizes the halos formation on the lenses of the glasses upon application, without rinsing and after drying with a specific cloth.

An example of an aqueous composition object of the invention is given below for illustrative but not limitative purposes; a formulation development study of said aqueous disinfectant composition; a study conducted to verify the effectiveness of the aqueous disinfectant composition object of the invention against the virus, in particular Covid-19.

### EXAMPLES

### Example 1 of a Aqueous Disinfectant Composition

| | % by weight on the total |
|---|---|
| Component | weight of the composition (w/w) |
| Denatured alcohol | 1-10% |
| Sodium cocoamphoacetate | 0.1-1.5 |
| Cetrimonium chloride | 0.05-0.5% |
| o-Cymen-5-ol | 0.05-0.2% |
| Imidazolidinyl urea | 0.1-0.6% |
| Disodium EDTA | 0.1-0.6% |
| Sodium chloride (formulation | 0.05-0.4% |
| ingredient present in the | |
| surfactant) | |

### Example 2 of an Aqueous Disinfectant Composition

| | % by weight on the total |
|---|---|
| Component | weight of the composition (w/w) |
| Denatured alcohol | 1-10% |
| Sodium cocoamphoacetate | 0.1-1.5% |
| Cetrimonium chloride | 0.05-0.5% |
| o-Cymen-5-ol | 0.05-0.2% |
| Magnesium nitrate | from 0.0001 to 0.0005% |
| methylisothiazolinone | 0.0001-0.001% |
| Magnesium chloride | 0.0001-0.001% |
| Imidazolidinyl urea | 0.1-0.6% |
| methylchloroisothiazolinone | 0.0005-0.003% |
| Disodium EDTA | 0.1-0.6% |
| Sodium chloride (formulation | 0.05-0.4% |
| ingredient present in the | |
| surfactant) | |

### Example 3—Formulation Development Study

### 1.1 Study Regarding the Choice of Surfactant

The choice of surfactant such as to confer washing capacity was carried out on the basis of an experimental test, and selecting three different surfactant candidates available in the research and development laboratories, such as: sodium lauryl ether sulphate, sodium cocoamphoacetate and cocamidopropyl betaine.

The test involved the preparation of three different aqueous solutions for each of the aforementioned surfactants at concentrations at 1% (w/w) by weight to the total weight of the aqueous solution, and the use of mirrored sunglasses. The test consisted of immersing the sunglasses in each of the three aqueous surfactant solutions; therefore, the mirrored sunglasses were dried with a specific cloth and without further rinsing.

The test carried out assessed three different characteristic parameters of the three aforementioned aqueous solutions of surfactants at 1% (w/w): foaming, degreasing capacity, possible presence of halos after drying.

From the test described it emerged that the surfactant characterized by the best performance was sodium cocoamphoacetate.

### 1.2 Study of Solubility, Compatibility and Halos Formation to Obtain the Aqueous Disinfectant Composition for Glasses.

Experimental tests were conducted to assess the compatibility of the disinfectant composition in the form of an aqueous solution with respect to the materials from which glasses are commonly manufactured (mode test (A)); a modality for the evaluation of the eventual halos formation following the use of the disinfectant composition in the form of an aqueous solution on the lens of the glasses (mode test (B)). In particular:
mode test (A): bath (or soaking) of the lens of the glasses in the disinfectant composition in the form of an aqueous solution for a time equal to 120 hours and evaluation of the integrity once dried and compared with a lens of non-soaked glasses and representing the “blank” sample;
mode test (B): application of the disinfectant composition claimed in the form of an aqueous solution on the lens of the glasses and subsequent drying with a specific cloth.

In order to obtain the disinfectant composition for the glasses in the form of an aqueous solution, an attempt was initially made to resolve the question of the reduced solubility in aqueous medium of the fat-soluble and needle-like shaped ingredient o-cymen-5-ol, with the use of PEG-40 hydrogenated castor oil, a solubilizing molecule widely used in cosmetics. The disinfectant composition in the form of an aqueous solution, including PEG-40 hydrogenated castor oil, was completely clear, and it was therefore decided to test its compatibility with different types of glasses using the mode test (A) and any halos formation with the mode test (B).

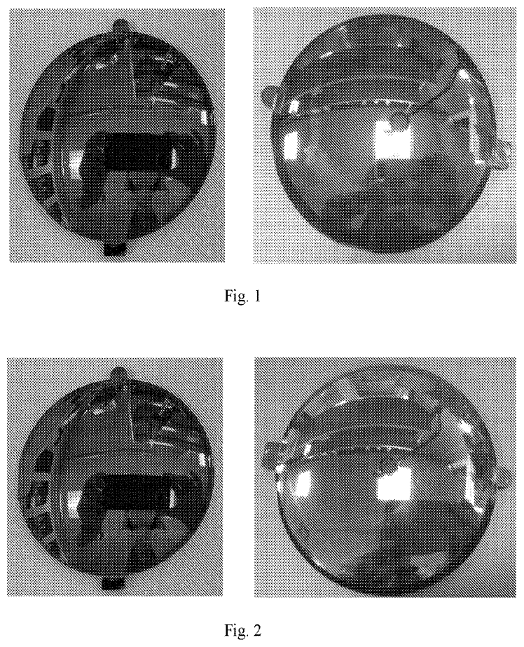

During the mode test (A), already after a period of soaking time of 48 hours, it was observed that the disinfectant composition in the form of an aqueous solution, including PEG-40 hydrogenated castor oil, irreversibly changed the appearance of the lens compared to “blank” sample. Even after the mode test (B), it was observed that the disinfectant composition in the form of an aqueous solution, containing the hydrogenated castor oil PEG-40, left residual halos on the lenses that were not acceptable. FIG. 1 compares a lens of mirrored glasses not soaked, representing the “blank” sample, and a lens soaked in the PROT composition. 2064 including the following.

| | |
|---|---|
| PROT. | Water, sodium cocoamphoacetate, sodium-EDTA, |
| 2064 | imidazolidinyl urea, o-cymen-5-ol, PEG-40 hydrogenated |
| | castor oil, sodium chloride |

FIG. 2 shows a comparison of a non-soaked mirrored lens, representing the “blank” sample, and a mirrored lens soaked in the PROT. 2071 composition comprising the following.

| | |
|---|---|
| PROT. | Water, sodium cocoamphoacetate, denatured alcohol, |
| 2071 | disodium-EDTA, imidazolidinyl urea, o-cymen-5-ol, |
| | PEG-40 hydrogenated castor oil, sodium chloride |

As shown in FIGS. 1 and 2, the main responsible for the degradation of the glasses, according to the mode test (A), was found to be PEG-40 hydrogenated castor oil; therefore, it was decided to replace PEG-40 hydrogenated castor oil with denatured alcohol for the solubilization of the active substance o-cymen-5-ol.

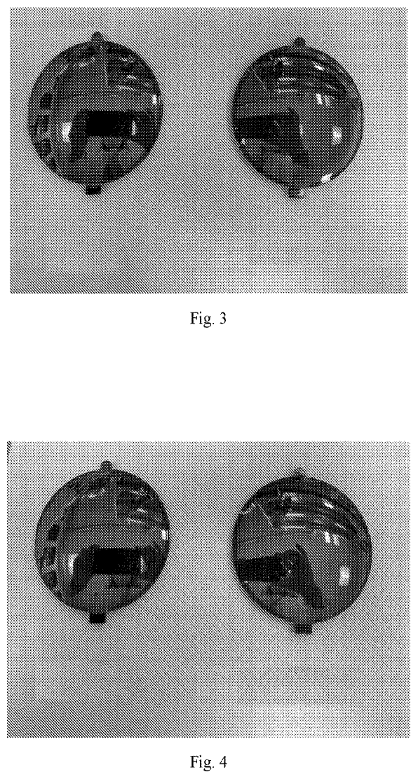

Another aspect that affects the integrity of the glasses, according to the mode test (A), and the formation of possible halos, according to the mode test (B), relates to the concentration of surfactant in aqueous composition. In particular, according to the mode test (A), the use of 4% surfactant concentrations (w/w) in a aqueous disinfectant composition (PROT. 2079) and after a 120-hour soaking time of the mirrored lens, caused a slight degradation (FIG. 3). According to the mode test (A), the reduction of the surfactant concentration up to 2% (w/w) in a aqueous disinfectant composition (PROT. 2080) and after a 120 hour soaking time of the mirrored lens, avoided any damage (FIG. 4). Hence, it was preferred to develop a aqueous disinfectant composition in surfactant concentrations<at 2% (w/w) by weight on the total weight of the aqueous disinfectant composition.

Since alcohol is also a potentially aggressive solvent for the materials of which the glasses are made of, the quantity has been balanced by using the minimum necessary, and, in particular, in amounts not exceeding 20% (w/w) by weight by weight total of the aqueous disinfectant composition, for the solubilization of o-cymen-5-ol. Furthermore, this choice also allowed to obtain a non-flammable composition.

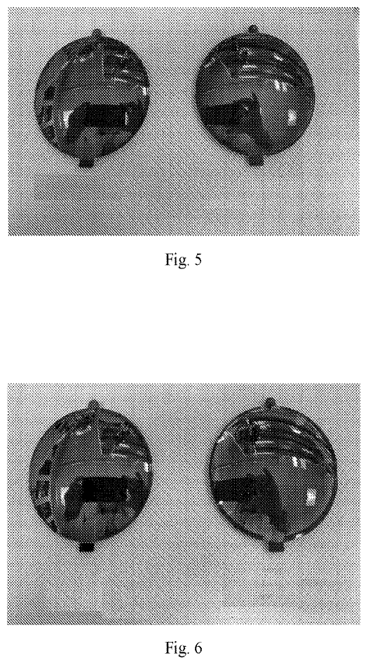

We also tried to add disodium-EDTA and it was found, quite unexpectedly, that it proved to be a strong stabilizer of the formula, making it less aggressive towards the lenses. Theoretically, EDTA, being a metal ion chelator, could have affected the mirroring of the lenses which contain mixtures of different metals, which did not happen. This appears evident in FIG. 5 representing the comparison between a non-soaked mirrored lens, or “blank” sample, and a mirrored lens after soaking in an aqueous disinfectant composition in the presence of disodium-EDTA (PROT. 2081). In this case, no degradation phenomenon or the presence of halos is observed demonstrating the stabilizing effect of disodium-EDTA. On the contrary, there is an evident degradation of a mirrored lens after soaking in a aqueous disinfectant composition in the absence of disodium-EDTA (PROT. 2082) if compared with a lens not soaked, or a “blank” sample (FIG. 6).

### Example 4—Antibacterial and Antiviral Efficacy Test Using the Aqueous Disinfectant Composition in Example 2

### 1.1 Antibacterial Efficacy Test Using the Aqueous Disinfectant Composition in Example 2

100 μl of a 1×10⁷ suspension colony forming units (CFU)/ml corresponding to 1×10⁶ CFU of bacterial and fungal strains, maintained under standard conditions and grown at 37° C. or 30° C. for 16 hours, were deposited on a surface of polystyrene and exposed to 200 μL of product for 30 seconds, 1 and 3 minutes.

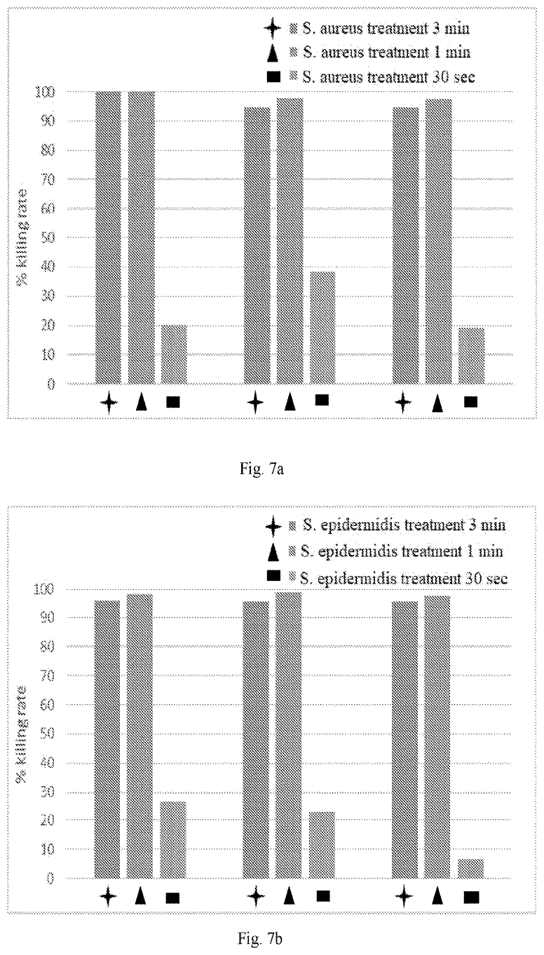

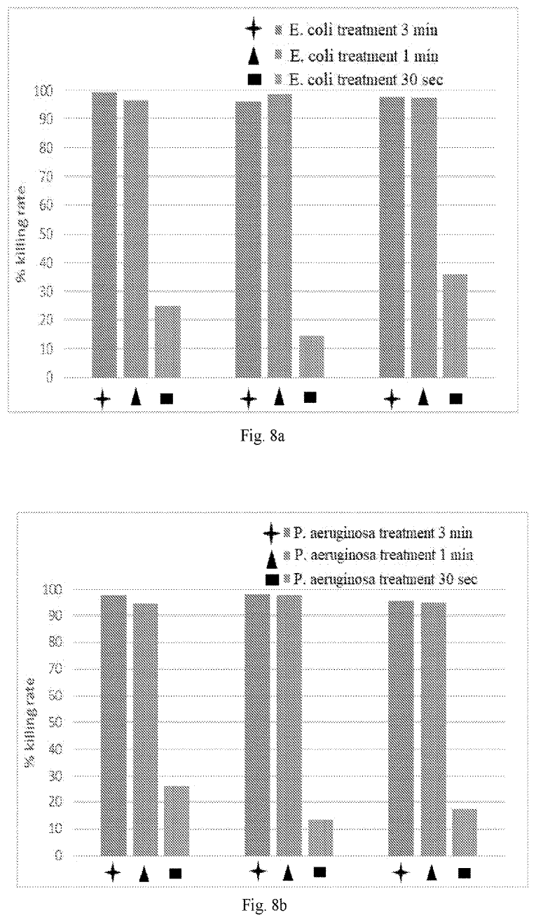

At the end of the treatment, the volume of microbial culture was collected, appropriately diluted and seeded in microbiological culture plates in order to evaluate the microorganism viability. The agar plates were incubated at 37° C. or 30° C. and the presence of microbial colonies monitored every 24 hours up to a maximum of 72 hours. The results are expressed as a percentage of reduction of microbial viability with reference to samples similarly prepared but not exposed to the formulation (FIG. 7a, 7b, 8a, 8b).

### 1.2 Antiviral Efficacy Test Using the Aqueous Disinfectant Composition in Example 2

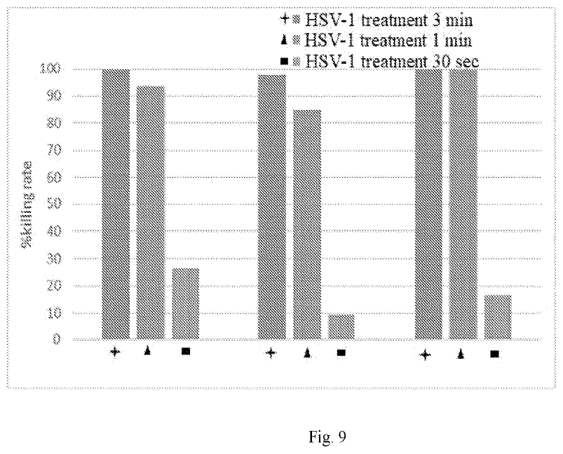

Similarly, tests were conducted using 100 μL of HSV-1 viral suspension. At the end of the treatment, the viral suspension was collected and diluted in a neutralization buffer in order to stop the effect of the disinfectant, is added to a monolayer of VERO cells, incubated at 37° C. for 48 hours in order to visualize the appearance of lysis plaques. The results were expressed as a percentage of reduction of infecting viral particles with reference to the control samples (FIG. 9).

2. Experimental Results of the Antibacterial (1.1) and Antiviral (1.2) Efficacy Tests after a 1 Minute Exposure Time

| | |
|---|---|
| Gram+ bacteria: S. aureus, S. epidermidis | Killing rate (1 min) >95% |
| Gram− bacteria: E. coli, P. aeruginosa | Killing rate (1 min) >95% |
| Enveloped virus: HSV-1 | Killing rate (1 min) >90% |

1. Aqueous disinfectant composition for glasses comprising the following active substances:
a) imidazolidinyl urea,
b) o-cymen-5-ol,
c) cetrimonium chloride.

2. Aqueous disinfectant composition according to claim 1, further comprising active substances d) and e) being respectively methylchloroisothiazolinone and methylisothiazolinone.

3. Aqueous disinfectant composition according to claim 1, containing the active substance a) at concentrations ranging from 0.1 to 1% by weight on the total weight of the composition.

4. Aqueous disinfectant composition according to claim 1, containing the active substance b) at concentrations comprised between 0.005 and 0.5% by weight on the total weight of the composition.

5. Aqueous disinfectant composition according to claim 1 containing the active substance c) at concentrations comprised between 0.05 and 1% by weight on the total weight of the composition.

6. Aqueous disinfectant composition according to claim 2, wherein the component d) present at concentrations comprised between 0.0005 and 0.01% by weight on the total weight of the composition.

7. Aqueous disinfectant composition according to claim 1, containing the active substance e) at concentrations ranging from 0.0001 to 0.01% by weight on the total weight of the composition.

8. Aqueous disinfectant composition according to claim 1, being also cleansing and therefore containing a surfactant selected from sodium cocoamphoacetate, sodium lauryl ether sulfate and cocamidopropyl betaine.

9. Aqueous disinfectant composition according to claim 8, containing sodium cocoamphoacetate at concentrations comprised between 0.05 and 5%, by weight on the total weight of the composition.

10. Aqueous disinfectant composition according to claim 1, containing a chelating agent.

11. Disinfectant composition according to claim 10, wherein the chelating agent is sodium-EDTA and is present at concentrations between 0.05 and 1% by weight on the total weight of said composition.

12. Disinfectant composition according to claim 1, containing a C2-C4 lower alcohol.

13. Aqueous disinfectant composition according to claim 12, wherein the lower alcohol is denatured alcohol, at concentrations comprised between 1 and 20%, by weight on the total weight of said aqueous composition.

14. Aqueous disinfectant composition according to claim 1 containing the active substance a) at concentrations ranging from 0.1 to 0.6%, by weight on the total weight of the composition.

15. Aqueous disinfectant composition according to claim 1 containing the active substance b) at concentrations comprised between 0.01 and 0.2%, by weight on the total weight of the composition.

16. Aqueous disinfectant composition according to claim 1 containing the active substance c) at concentrations comprised between 0.05 and 0.8% by weight on the total weight of the composition.

17. Aqueous disinfectant composition according to claim 1, wherein the active substance d) is present at concentrations comprised between 0.0005 and 0.005%, by weight on the total weight of the composition.

18. Aqueous disinfectant composition according to claim 1, containing the active substance e) at concentrations ranging from 0.0001 to 0.001%, by weight on the total weight of the composition.

19. Aqueous disinfectant composition according to claim 9, containing sodium cocoamphoacetate at concentrations comprised between 0.1 and 1.5%, by weight on the total weight of the composition.

20. Aqueous disinfectant composition according to claim 11, wherein sodium EDTA is present at concentrations between 0.1 and 0.6% by weight on the total weight of the composition.

21. A method for disinfecting glasses, comprising applying on the surface thereof an aqueous disinfectant composition comprising the following active substances:
a) imidazolidinyl urea,
b) o-cymen-5-ol,
c) cetrimonium chloride.

22. A method for disinfecting and cleansing glasses, comprising applying on the surface thereof an aqueous composition comprising
the following active substances:
a) imidazolidinyl urea,
b) o-cymen-5-ol,
c) cetrimonium chloride, and
a surfactant selected from sodium cocoamphoacetate, sodium lauryl ether sulfate and cocamidopropyl betaine.
